(19) United States
(12) Patent Application Publication
(10) Pub. No.: US 2004/0122952 A1
(43) Pub. Date: Jun. 24, 2004

(54) Optimizing network connections in a data processing system with multiple network devices

(75) Inventors: Michael David Kistler, Pflugerville, TX (US); Ramakrishnan Rajamony, Austin, TX (US); Freeman Leigh Rawson III, Austin, TX (US); Eric Van Hensbergen, Austin, TX (US)

Correspondence Address: LALLY & LALLY LLP, PO BOX 684749, AUSTIN, TX, 78768-4749, US

(73) Assignee: International Business Machines Corporation, Armonk, NY

(21) Appl. No.: 10/324,740

(22) Filed: Dec. 18, 2002

(51) Int. Cl. G06F 15/16

(52) U.S. Cl. 709/227

(57) ABSTRACT

A data processing system for communicating over a network includes at least two network connection devices. The system selects one of the connection devices in response to a request for a network communication. The system may deactivate at least one of the connection devices not selected and initiate the requested network communication using the selected connection device. The system may select the optimal connection device for the particular communication based upon a set of parameters associated with each connection device. These parameters may include connection device's bandwidth, cost, and security. One or more of the parameter values for each connection devices may be negotiated with a service provider. The system may deactivate at least one of the connection devices by turning off all of the connection devices not selected for the network communication. The system may further turn off the selected connection device after the communication is terminated.

### BACKGROUND

1. Field of the Present Invention

The present invention is in the field of network enabled data processing systems and more particularly to data processing systems having multiple network connection devices.

2. History of Related Art

In the field of network enabled data processing systems, it is increasingly common to encounter devices that have multiple network connection devices (also referred to as network devices, network interface cards (NICs), network adapters, and various other names). Commercially distributed lap top and desktop computers, for example, are now available with wired Ethernet network devices, wireless Ethernet devices, and Bluetooth™ compliant network devices. Providing a variety of network devices improves the ability of the network aware device to connect to a network. In addition to conventional data processing systems, this multiple communication device flexibility is being employed in pervasive devices such as cellular telephones, personal digital assistants (PDAs), and so forth. In these applications, the use of multiple network devices, while offering increased access to networked resources, is typically implemented in a relatively simplistic fashion that fails to differentiate between network parameters associated with each network device. In addition, the use of additional network devices adds an undesirable drain on the power supply (battery). This problem is especially pronounced in designs where power is supplied indiscriminately to all of the network devices even when none or only one of the devices is active. Power conservation is particularly important in the context of hand-held devices where manufacturers are always searching for ways to increase the battery lifetime. It would be desirable to implement a system employing multiple network devices in which the selection of which network device to use is optimized based on a set of criteria that may include power consumption, performance, reliability, cost, and so forth.

### SUMMARY OF THE INVENTION

The problems identified above are addressed by a data processing system for communicating over a network. The system includes at least two network connection devices. The system selects one of the connection devices in response to a request for a network communication. The system may deactivate at least one of the connection devices not selected and initiate the requested network communication using the selected connection device. The system may select the optimal connection device for the particular communication based upon a set of parameters associated with each connection device. These parameters may include connection device's bandwidth, cost, and security. One or more of the parameter values for each connection devices may be negotiated with a service provider. The system may deactivate at least one of the connection devices by turning off all of the connection devices not selected for the network communication. The system may further turn off the selected connection device after the communication is terminated.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing system according to one embodiment of the present invention;

FIG. 2 is a conceptual diagram of software components of a data processing system according to one embodiment of the invention;

FIG. 3 is a conceptual diagram of selected components of a data processing network configuration according to one embodiment of the invention;

FIG. 4 illustrates a table suitable for use in a data processing system having multiple network connection devices; and

FIG. 5 is a flow diagram of a method of network communication according to one embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF A PREFERRED EMBODIMENT OF THE PRESENT INVENTION

Generally speaking, the present invention contemplates a data processing system configured with multiple network connection devices and a method for selecting and activating one of the network connection devices. The selection and activation of one of the network connection devices may be based on a set of parameters or constraints defined by the user, the network, or a combination of both. Network connection devices that are not selected may be powered down to conserve power consumption and prolong battery life, which is especially beneficial in mobile systems.

The selection of the most appropriate network connection device may be based on user-defined preferences for various network parameters such as speed or bandwidth, security, and cost. The parameters associated with each network connection device may change dynamically and the system may determine various parameters through communication or negotiation with a service provider. In this manner, the invention enables the system to take maximum advantage of its multiple network connection device capabilities by tailoring the network connection device to the particular network transmission requested. In addition, by activating a single network connection device while maintaining the other network connection devices in a low power state, the invention extends the operating life of mobile embodiments of the system.

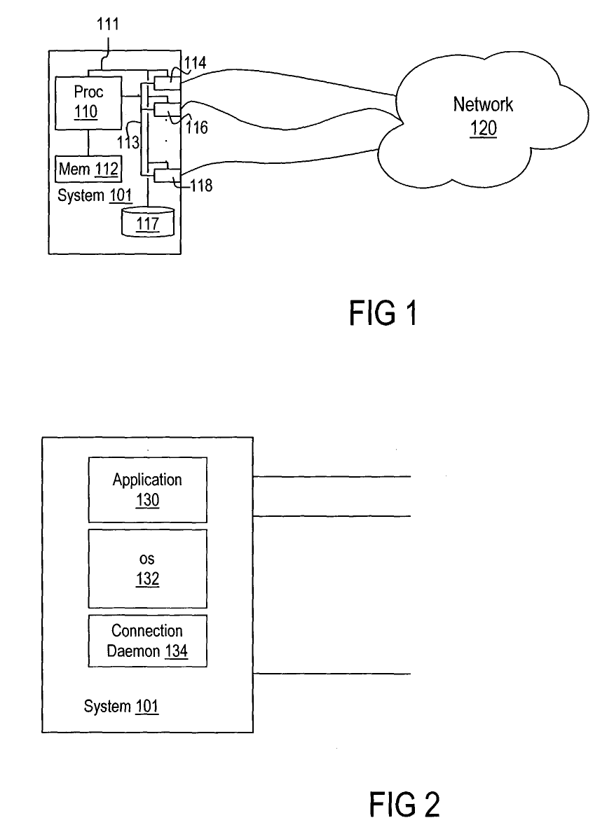

Referring now to FIG. 1, selected hardware elements of a data processing system 101 according to one embodiment of the present invention are presented. As depicted in FIG. 1, data processing system 101 includes a processor 110, memory 112, multiple network connection devices 114, 116, and 118, and a power source such as battery 117. A power bus or signal, 111 connects battery 117, processor 110 and each of the network connection devices 114 through 118. As its name implies, power bus 111 enables processor 110 to selectively power network connection devices 114 through 118. A logic bus or peripheral bus 113 also connects processor 110 and network connection devices 114 through 118. Processor 110 may be implemented with a general purpose processor, an embedded processor, or an application specific integrated circuit (ASIC). Regardless of the implementation, processor 110, for purposes of this invention, is generally configured to execute instructions to provide data to network connection devices 114 through 118. The network connection devices are then responsible for modifying the information received from processor 110 and formatting it in a manner suitable for transmission over the corresponding network.

In various embodiments, data processing system 101 may be implemented as a desk top or lap top computer, a cellular telephone, a PDA, or the like. Similarly, network connection devices 114 through 118 may include wired Ethernet devices, wireless Ethernet devices, Bluetooth devices, DSL modem devices, and so forth. Each of the devices as depicted in FIG. 1 is connected to a power source such as battery 117.

In one embodiment, data processing system 101 is configured to respond to a request (from a user or application program) for network communication by selecting one of the network connection devices over which to route the communication. The depicted embodiment of system 101 is further configured to power down the network connection devices not selected to transmit the communication. Each of the network connection devices 114 through 118 provides a connection to a network 120, which may represent, for example, a corporation's intranet or the Internet.

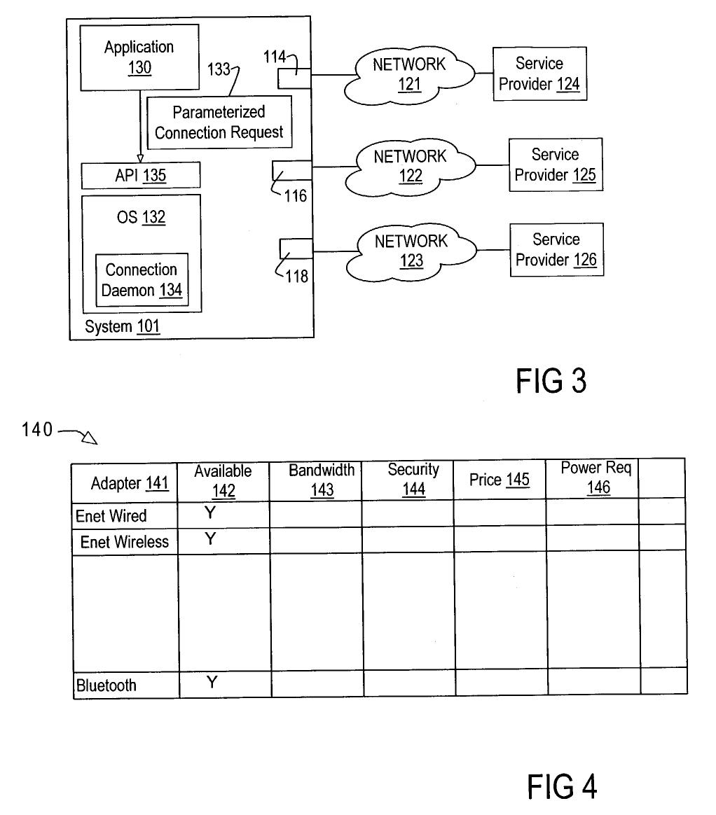

Referring now to FIG. 2, selected elements software elements suitable for use in one embodiment of data processing system 101 are illustrated. In the depicted embodiment, data processing system 101 includes one or more application program(s) 130, an operating system 132, and a connection daemon 134. Application program 130, in the context of this invention, is generally exemplified by a class of programs that enable users to transmit and receive information with other data processing systems (not depicted) via one or more network(s) 120. Application program 130 may represent, for example, a conventional web browser whether it be a desktop-based web browser or a browser specifically designed for use in a portable or hand-held device.

Operating system 132 is responsible for managing the resources of data processing system 101 including any memory resources, process scheduling, I/O, and so forth. Operating system 132 also provides an environment in which application program 130 can execute. Operating system 132 could represent a Unix-based operating system such as the AIX® operating system from IBM Corporation, a Windows® family operating system from Microsoft Corporation, or an embedded operating system designed for use in portable devices such as the eCos operating system developed by Red Hat and 3G LAB.

Data processing system 101 according to the embodiment depicted in FIG. 2 further includes a connection daemon 134. As its name suggests, connection daemon 134 is low-level code that executes indefinitely below operating system 132. In other embodiments, connection daemon 134 may be implemented as an integral part of the operating system's network code, a user-level daemon process that the network code in the operating system invokes prior to establishing a connection, or an interposition library that maps the network device and/or address selected by the user program to the optimal physical network interface. Connection daemon 134 is configured to select and activate one of multiple network connection devices in response to a network connection request. Typically, a user of application 130 will initiate the connection request such as by entering a URL in a conventional web browser and thereby generating an HTTP GET request or other such command. Operating system 132, in the embodiment depicted in FIG. 2 delegates the connection request to connection daemon 134 in a manner similar to the manner in which an operating system would delegate an application program print request to a print spooler.

Connection daemon 134 is specifically configured to monitor the available network connection devices in data processing system. In response to a connection request, connection daemon 134 determines which of the network connection devices is most appropriate to handle the current connection request. The determination of the most suitable network connection device may be based on a set of constraints that may be user defined or installed by the device manufacturer, or a combination of both.

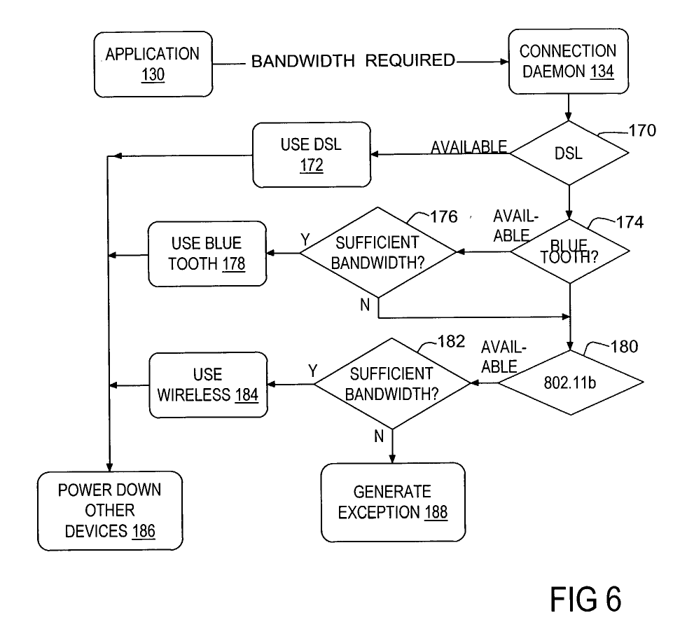

Referring to FIG. 4, a conceptual depiction of a table 140 that may be employed by connection daemon 134 is depicted. In this illustration, connection daemon 134 maintains an entry in table 140 for each network connection device that exists on system 101. For each such network connection device, table 140 contains information that may be used by connection daemon 134 to determine the most appropriate connection for a pending connection request. The information in table 140 maintained for each network connection device entry may include, by way of example, availability information 142, bandwidth information 143, security information 144, price information 145, power requirement information 146, and so forth. Connection daemon 134 may poll the various network devices from time to time (periodically or asynchronously) to detect changes in the state of any network connection devices.

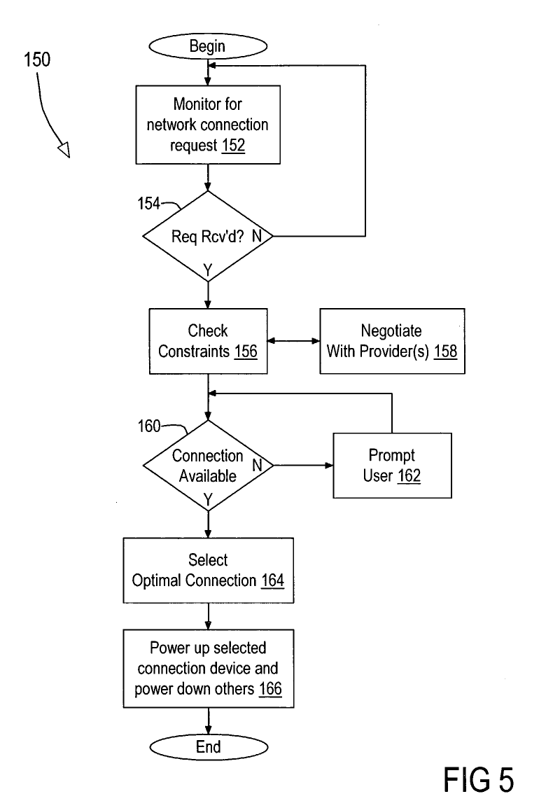

Availability information 142 may indicate whether the corresponding network connection device is currently available for service. If the network connection device is a wired Ethernet adapter, as an example, and the data processing system is in a car, the wired adapter would not be available for service. Similarly, for a wireless adapter that is out of range of its wireless signal, the adapter would be unavailable. This availability information might be maintained by indicating a bandwidth of 0 in bandwidth information column 143. Otherwise, the bandwidth information is indicative of the rate at which data may be transceived (transmitted or received) over the corresponding network. Bandwidth information may be based on historical data where data processing system or the network connection devices themselves calculate and maintain data rate information. Bandwidth approximations can be made based upon time stamp information that is typically contained in data packets that are transmitted over a network. Security information 144 may indicate the level and/or type of encryption in use by the corresponding network connection device while price information 145 reflects the cost of transceiving data over the connection. Price information 145 may be relatively static for a given network connection device or it may vary relatively slowly. For example, a particular network may charge users more during business hours than during weekends or other time periods of relatively low activity. In one embodiment, price information 145 may result from negotiation between the user of system 101 and some form of service provider. In another embodiment, the price information may change depending on whether the service provider is a preferred (pre-negotiated) service provider or not. These implementations are illustrated with respect to the embodiment of system 101 depicted in FIG. 3.

As shown in FIG. 3, data processing system 101 employs an application program interface (API) 135 that enables application program 130 to make parameterized network connection requests (indicated by reference numeral 133) to operating system 132. In the depicted embodiment, connection daemon 134 is embedded or integrated within operating system 132. In the depicted embodiment, each network connection device 114 through 118 is connected to a unique network service provider 124 through 126 via a corresponding network 121 through 123. Although depicted as distinct networks, networks 121 through 123 may share common elements. Service providers 121 through 123 may be configured with tools (software and/or hardware) that is compliant with the connection API used by data processing 101. When a network request is to be initiated, the user or another entity such as operating system 132 interrogates the various service providers 124 through 126 to provide network metric information such as information of the type suitable for storage in table 140 as depicted in FIG. 4. In response to such a request, each service provider 124 through 126 may return bandwidth, security, and price information as well as other information to device 101. The operating system 132 might then delegate the connection task to a program such as the daemon 134 shown in FIG. 2.

In another embodiment of device 101 as depicted in FIG. 3, the user or other entity, rather than just receiving unilaterally determined network information from each service provider, may negotiate with the various providers for service at the time of the connection request. In this embodiment, application program 130 might convey one or more preferences or network connection constraints to service providers 124 to 126, preferably through the use of or in compliance with API 135. The preferences expressed by application 130 might be taken from table 140 might include, for example, the desired speed (bandwidth) and security level. In one embodiment, the connection daemon might send the preference information to each network connection device where the request would be forwarded to the appropriate service provider(s). The service provider(s) would respond by indicating the price of a connection at the requested level of speed and security. Similarly, application 130 could constrain the price the user is willing to pay and receive, for example, the bandwidth each provider is willing to guarantee at the price level specified. In the context of the invention, price may include factors other than simply dollars. Pricing may include, for example, a consumer's willingness to accept delivery of advertisements or to provide survey information to the service provider.

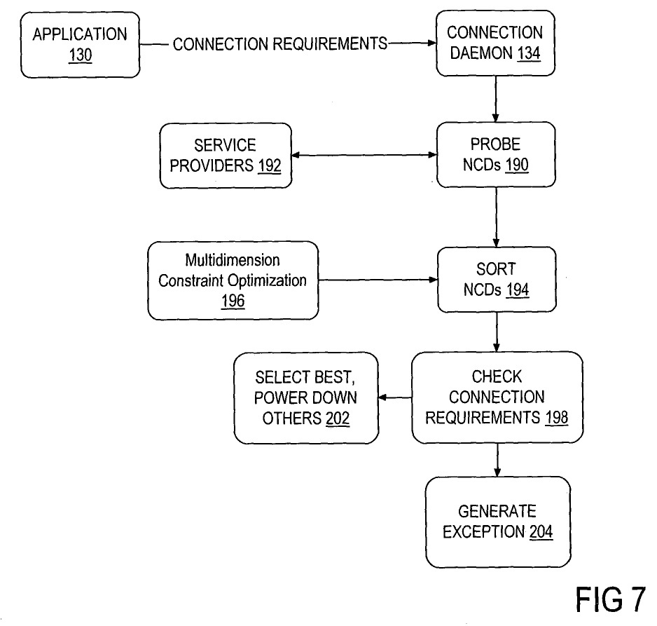

This embodiment of the invention is illustrated in FIG. 5 as a method 150 in flow diagram format. The depicted embodiment of method 150 includes monitoring (block 152) for a network connection request. This block contemplates a connection daemon or similar such code that executes continuously for an application issuing a command or request that requires a network connection. Upon receiving a request (block 154), the connection daemon or operating system may check (block 156) any constraints, such as a minimum bandwidth, minimum level of security, or a maximum price, that are embedded in the request. In some embodiments, as discussed above, a parameterized request for a connection may include a set of constraints or requirements and one or more parameters that are negotiated with the network service provider(s).

In yet another embodiment, the network information would be negotiated with a portal entity separate from the service providers. After negotiation, the portal entity would provide device 101 with the parameters of the connections that can be established with the different service providers. The portal entity would then provide device 101 with authorization token(s) that can be used to establish a network connection through a particular service provider.

When all parameters or constraints associated with a connection request are known, either through negotiation with a service provider, through receiving information from a table such as table 140, or a combination of both, the operating system or daemon can determine whether there is any network connection device that fulfills all requirements of the connection and/or meets all constraints. If no such network connection device is currently available, the system may prompt (block 162) the application user to relax one or more connection constraints or abort the connection.

If one or more network connection devices is available, the system selects the optimal connection based on the expressed constraints and any default values. In some cases, the optimal connection will be determined trivially such as when, for example, all other parameters are equal, but a first network connection device represents a cheaper connection than a second. In other cases, the optimal connection may not be readily apparent, such as when a first network connection device is a cheaper but slower connection than a second connection. In such cases, the system may prompt the user to select among the various alternatives and display the connection parameters of each eligible network connection device. Alternatively, the system may make a rule based evaluation of the available network connection devices to determine automatically which connection is most suitable. In a rule based embodiment, connection daemon 134 is preferably configured to “learn” user preferences based on past decisions and applying these learned preferences in its rule base. A connection daemon for a particular system owned or operated by a user with a demonstrated strong preference for the fastest connection possible will, for example, configure its rules to prioritize bandwidth above other possible determining factors.

Ultimately, an optimal connection is selected (block 164) from among the one or more eligible network connection devices. In the preferred embodiment, system 101 then powers the selected network connection device while shutting off power or otherwise reducing power (block 166) to all remaining network connection devices. In some embodiments, the system may power the selected connection for the duration of the associated connection and then terminate power. In these embodiments, all network connection devices may be powered down when there are no pending connection requests. In other embodiments it may be beneficial from a performance perspective to maintain at least one network connection device, such as the network connection device that was determined to be optimal for the most recent network connection request, in a powered state.

Referring now to FIG. 6, a conceptual illustration of the interaction that occurs in response to a network request is depicted. FIG. 6 illustrates a relatively simplistic case in which the system has three network connection devices, a hard connection such as a DSL line connected via a wired Ethernet device, a Bluetooth device, and a wireless Ethernet (802.11b) device, and the only parameter of interest is the bandwidth or speed of the connection. In the depicted example, application program 130 sends a bandwidth requirement to connection daemon 134. The daemon prioritizes the network connection devices based on the parameter(s) of interest which, in this case, is bandwidth. Accordingly, the connection daemon first checks (block 170) the availability of the DSL device, which has the highest bandwidth. If the DSL device is available, it is selected (block 172) as the active or current network connection device. If the DSL device is unavailable, perhaps because the system is a portable device that is currently not near the DSL cable, the connection daemon checks (block 174) the availability of its Bluetooth device. If the Bluetooth device is available and has sufficient bandwidth (block 176), it is selected (block 178) as the active network connection device. If the Bluetooth device is unavailable or lacks sufficient bandwidth, the availability and bandwidth of the wireless Ethernet device is checked (blocks 180 and 182). If the wireless Ethernet device is available with sufficient bandwidth, it is selected (block 184) as the active network connection device. If any of the network connection devices is selected, the connection daemon turns off (block 186) the unselected network connection devices to conserve power. If none of the network connection devices has availability and sufficient bandwidth an exception is issued (block 188).

A more generalized illustration of the invention is presented in FIG. 7 where application program 130 provides connection daemon 134 with a generalized set of connection requirements that may indicate bandwidth requirements, security requirements, etc. The connection daemon may then probe the various network connection devices (block 190) to determine connection parameters for each network connection device. The probing of each network connection device may include interaction or negotiation with services providers (block 192). After determining the characteristics of each network connection device, the network connection devices may be sorted or prioritized (block 194) by casting the problem in a dimensional constraint optimization framework and solving it (block 196). After prioritizing the connections in this manner, the connections may then be checked (block 198) in the order or priority against the connection requirements specified by the user to determine if any of the connections is satisfactory. If none of the connections meets the required criteria, an exception is generated (block 204). Otherwise, the highest priority connection that meets the connection criteria is selected (block 202) as the active network connection device while the remaining network connection devices are powered down.

To illustrate the concept of constraint optimization, the map coloring problem is described briefly. In this problem, countries in a two-dimensional map must be colored subject to the constraint that no two adjacent countries are colored using the same color. Although the problem has a trivial solution obtained by simply coloring each country with a distinct color, the goal of the problem is to obtain a solution that satisfies the constraint, while using the least number of colors (hence the term constraint optimization). In a similar manner, the parameters of each network connection device can be applied to an equation that when evaluated, yields the “utility” of that device for a particular usage scenario. The constraints could be user specified and may specify upper bounds on power consumption, price, and a lower bound on sustained available bandwidth. Given the “utility” equation and the constraints, a constraint optimization solver can be used to ascertain the network connection device that provides the most “utility” for the least cost, while satisfying all the constraints.

The embodiments described above encompass cases in which the network communication is initiated by system 101. In some embodiments, any of the network connection devices 114, 116, and 118 may be configured to receive asynchronously arriving transmissions, perhaps sitting in a partially powered state while they do so. In addition, the network communication devices may be configured to “wake up” and poll periodically for incoming transmissions. In either case, system 101 may be configured to negotiate with the network to route subsequent incoming packets to a different, more optimal network connection device based on parameters passed from the network with the initial incoming packet. If, for example, network communication device 114 receives a transmission and system 101 determines that the transmission would be more optimally received by device 116, system 101 could communicate or negotiate with the transmitter of the communication to direct subsequent packets to device 116. In this manner, the optimal network communication device may be selected for incoming as well as outgoing transmissions.

It will be apparent to those skilled in the art having the benefit of this disclosure that the present invention contemplates a method and system for conserving power in system with multiple connection devices and for optimizing the network connection for a particular connection request. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A data processing device, comprising:
at least two network connection devices each enabling the device to communicate via a network;
means for selecting one of the network connection devices responsive to a request for a network communication, wherein the selection is based a comparison of parameters associated with each network connection device;
means for deactivating at least one of the network connection devices not selected; and
means for processing the requested network communication using the selected network connection device.

2. The system of claim 1, wherein the parameters associated with each network connection device include parameters selected from the group consisting of the network connection device's bandwidth, cost, power requirements, and security.

3. The system of claim 1, wherein the means for selecting one of the network connection devices includes means for negotiating a parameter value for at least one of the network connection devices with a service provider.

4. The system of claim 1, wherein the set of network connection devices include a wired Ethernet devices, wireless Ethernet devices, and Bluetooth network device.

5. The system of claim 1, wherein the means for deactivating at least one of the network connection devices comprises means for turning off all of the network connection devices not selected for the network communication.

6. The system of claim 5, further comprising means for turning off power to the selected network connection device after the communication is terminated.

7. The system of claim 1, wherein the request for a network communication is initiated by the system and wherein the means for processing the requested network transmission comprise means for transmitting information using the selected network communication device.

8. The system of claim 1, wherein the request for a network communication is initiated by an agent on the network and wherein the means for processing the requested network transmission comprise means for receiving information using the selected network communication device.

9. A method of communicating information over a network comprising:
responsive to a request for a network connection, selecting a network connection device from among a set of network connection devices associated with a data processing device based on a comparison of network parameters associated with each network connection device;
reducing power consumption of the network connection devices not selected; and
initiating the network communication via the selected network connection device.

10. The method of claim 9, wherein the network parameters include bandwidth criteria, security criteria, power requirements, and cost criteria.

11. The method of claim 10, wherein at least one of the network parameters may be negotiated with a network service provider.

12. The method of claim 9, wherein reducing power consumption comprises turning off power to each of the network connection devices not selected.

13. The method of claim 12, further comprising, following completion of the network communication, turning power off to the selected network connection device.

14. A computer program product comprising computer executable instructions for communicating information over a network, the computer program product residing on a computer readable medium, comprising:
code means for selecting a network connection device from among a set of network connection devices associated with a data processing device responsive to a request for a network connection, wherein the selection is based on a comparison of network characteristics associated with each network communication device;
code means for reducing power consumption of the network connection devices not selected; and
code means for initiating the network communication via the selected network connection device.

15. The computer program product of claim 14, wherein the network characteristics include bandwidth criteria, security criteria, power requirements, and cost criteria.

16. The computer program product of claim 15, wherein at least one of the network characteristics may be negotiated with a network service provider.

17. The computer program product of claim 14, wherein reducing power consumption comprises turning off power to each of the network connection devices not selected.

18. The computer program product of claim 20, further comprising, following completion of the network communication, turning power off to the selected network connection device.

19. A computer network, comprising:
a data processing device having at least two network connection devices each enabling the device to communicate via the network and further having means for selecting one of the network connection devices responsive to a request for a network communication, wherein the selection is based a comparison of network parameters associated with each network connection device;
at least one provider network services connectable to at least one of the data processing device's network connection devices; and
means enabling the data processing device and the provider to negotiate a value for at least one of the network parameters.

20. The network of claim 19, wherein the negotiated network parameters include at least one parameter selected from connection speed, connection price, and connection security level.
